(19) United States
(12) Patent Application Publication
(10) Pub. No.: US 2020/0244937 A1
(43) Pub. Date: Jul. 30, 2020

(54) IMAGE PROCESSING APPARATUS AND METHOD, AND PROGRAM

(71) Applicant: SONY CORPORATION, TOKYO (JP)

(72) Inventors: HARUKA MITSUMORI, KANAGAWA (JP); MOTOKI KUBO, KANAGAWA (JP)

(21) Appl. No.: 16/486,185

(22) PCT Filed: Feb. 14, 2018
(86) PCT No.: PCT/JP2018/004980

§ 371 Date: Aug. 15, 2019

(30) Foreign Application Priority Data
Feb. 27, 2017 (JP) 2017-034785

(51) Int. Cl. H04N 9/31; H04N 17/02

(52) U.S. Cl. CPC H04N 9/3191; H04N 17/02

(57) ABSTRACT

This disclosure relates to an image processing apparatus and a method, and a program that enable determination of the position and the shape of a PSF in a projection plane. The small pattern is a pattern that has a total of 35 dots of lateral seven dots×longitudinal five dots all being arranged therein at intervals of each 14 pixels, and a line having a width of one pixel (an outer frame) surrounds the 35 dots. A test pattern having the plurality of small patterns arranged therein and to be projected onto the overall screen is projected from a projector. From an image obtained by imaging this state using a camera, a PSF (Point Spread Function) of the projector is determined. This disclosure is applicable to, for example, a projection imaging apparatus that projects an image using a projector, that images the image projected by the projector, and that calculates the PSF.

### TECHNICAL FIELD

This disclosure relates to an image processing apparatus and a method, and a program and, more particularly, to an image processing apparatus and a method, and a program that enable determination of the position and the shape of a PSF in a projection plane even when the image processing apparatus is not a special device.

### BACKGROUND ART

For a PSF (Point Spread Function) of a projector in a projection plane, a proposal has been made according to which a test pattern is projected into a projection plane, a distribution of the dimension of the test pattern is estimated from an image obtained by imaging the test pattern, and blurring correction in the projection plane is executed using the estimated distribution. For example, in NPL 1, a test pattern having a plurality of cross-shaped test patterns lined in the projection plane is used.

### CITATION LIST

### Non Patent Literature

### [NPL 1]

Michael S. Brown, Peng Song, and Tat-Jen Cham, “Image Pre-conditioning for Out-of-Focus Projector Blur,” Computer Vision and Pattern Recognition, 2006 IEEE Computer Society Conference on 9 Oct. 2006, 9 Oct. 2006

### SUMMARY

### Technical Problem

With the above technique, it is however difficult to determine what shape the PSF has at each of positions in the projection plane and to determine the PSF for a scale of one pixel of the projector.

This disclosure was conceived in view of the above circumstances and can determine the position and the shape of the PSF in the projection plane.

### Solution to Problem

An image processing apparatus in one aspect of this technique includes a PSF calculating part that projects a test pattern having a plurality of small patterns arranged in an overall projection plane, the plurality of small patterns each having a plurality of one-pixels arranged at predetermined intervals each in a predetermined area, and that calculates a PSF (Point Spread Function) of a projector at each of positions in the projection plane, using an imaged image obtained by imaging the projected test pattern.

A number is added to the small pattern as the position information.

A binary code is added to the small pattern as the position information.

A QR code (a registered trademark) is added to the small pattern as the position information.

The PSF calculating part may include a PSF dot size calculating part that calculates a PSF of a camera scale and a dot size using the imaged image, and a projector PSF calculating part that calculates a PSF of the projector by scaling the PSF of the camera scale calculated by the PSF dot size calculating part, using the dot size calculated by the PSF dot size calculating part.

The test pattern is used for Structured Light (SL).

The test pattern is used for Imperceptible Structured Light (ISL).

In an image processing method in an aspect of this technique, an image processing apparatus projects a test pattern having a plurality of small patterns arranged in an overall projection plane, the plurality of small patterns each having a plurality of one-pixels arranged at predetermined intervals each in a predetermined area, and calculates a PSF (Point Spread Function) of a projector at each of positions in the projection plane, using an imaged image obtained by imaging the projected test pattern.

In an aspect of this technique, a test pattern having a plurality of small patterns arranged in an overall projection plane, the plurality of small patterns each having a plurality of one-pixels arranged at predetermined intervals each in a predetermined area. A PSF (Point Spread Function) of a projector at each of positions in the projection plane is calculated using an imaged image obtained by imaging the projected test pattern.

### Advantageous Effect of Invention

According to this technique, the position and the shape of the PSF in the projection plane can be determined.

The effect described herein is absolutely an exemplified effect, the effect of this technique is not limited to the effect described herein, and any additional effect may be present.

### BRIEF DESCRIPTION OF DRAWINGS

FIG. 1 is a diagram depicting an example of the state of detection of a corresponding point.

FIG. 2 is a diagram explaining an example of ISL.

FIG. 3 is a diagram depicting an example of the configuration of a small pattern in a test pattern to which this technique is applied.

FIG. 4 is a diagram depicting an example of the overall test pattern that has a plurality of small patterns depicted in FIG. 3 arranged therein and that is projected into the overall image.

FIG. 5 is a block diagram depicting an example of the configuration of a projection imaging system to which this technique is applied.

FIG. 6 is a block diagram depicting an example of the configuration of a PSF dot size calculating part.

FIG. 7 is a block diagram explaining a PSF calculation process.

FIG. 8 is a diagram depicting an example of an imaged image obtained by imaging only one small pattern.

FIG. 9 is a diagram depicting an example of an imaged image obtained by imaging a plurality of small patterns at one time.

FIG. 10 is a flowchart explaining a camera scale PSF and dot size calculation process.

FIG. 11 is a diagram depicting an example of information to be added to the small pattern.

FIG. 12 is a diagram depicting another example of the information to be added to the small pattern.

FIG. 13 is a diagram depicting still another example of the information to be added to the small pattern.

FIG. 14 is a diagram depicting yet another example of the information to be added to the small pattern.

FIG. 15 is a diagram depicting an example of a pattern indicating position information using the number and the arrangement of one-dots included in an outer frame.

FIG. 16 is a diagram depicting an example of the pattern indicating the position information using the brightness of one dot included in the outer frame.

FIG. 17 is a diagram depicting an example of the pattern indicating the position information using the value of an RGB channel of one dot included inside the outer frame.

FIG. 18 is a block diagram depicting an example of the hardware configuration of a computer to which this technique is applied.

### DESCRIPTION OF EMBODIMENT

A form to implement this disclosure (hereinafter, referred to as an embodiment) will be described below.

### <Background>

To estimate the postures of a projector and a camera, a corresponding point between the projector and the camera needs to be detected. This corresponding point detection process is generally called Structured Light (SL).

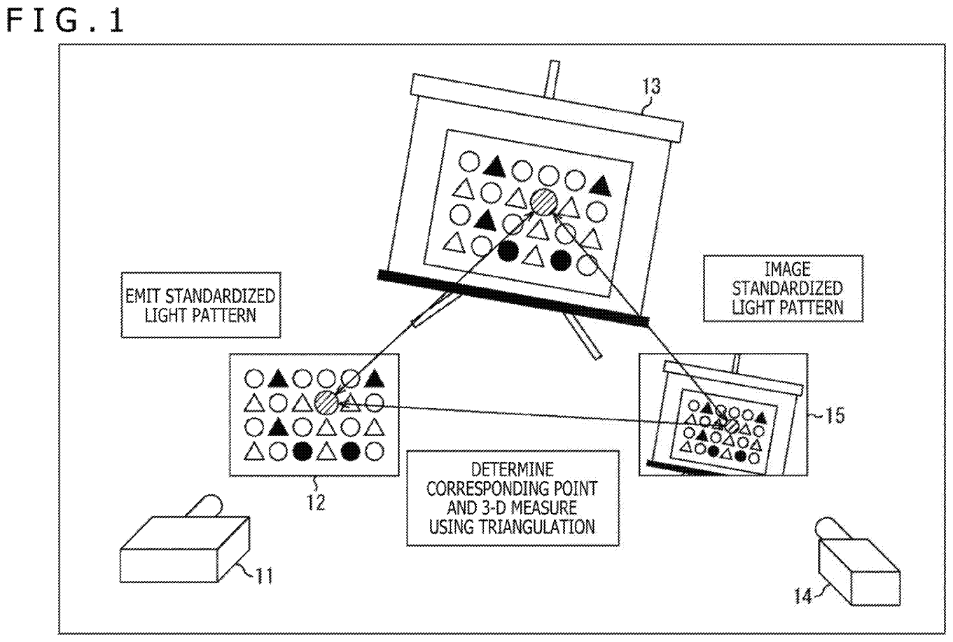

For example, as in an example in FIG. 1, a standardized-light pattern 12 having a predetermined picture pattern is projected from a projector 11 to a screen 13, and an imaged image 15 is obtained by imaging the projected standardized-light pattern 12 using a camera 14. A corresponding point of the standardized-light pattern 12 and the imaged image 15 is thereafter determined on the basis of the picture pattern of the standardized-light pattern 12. The postures (the positional relation) of the projector 11 and the camera 14, the shape of the screen 13, and the like are determined using triangulation or the like on the basis of the corresponding point, and the postures of the projector and the camera can be estimated on the basis of this result.

To detect the corresponding point between the projector and the camera as above, the image desired to be projected from the projector (a pattern image such as a gray code, a dot, a checker or the like, or an input image, or the like) needs to be imaged using a camera. When the image is a still image (a pattern image or a still video image), because the same video image is always projected, a desired image can be imaged, and the corresponding point can be detected even without matching the imaging timing.

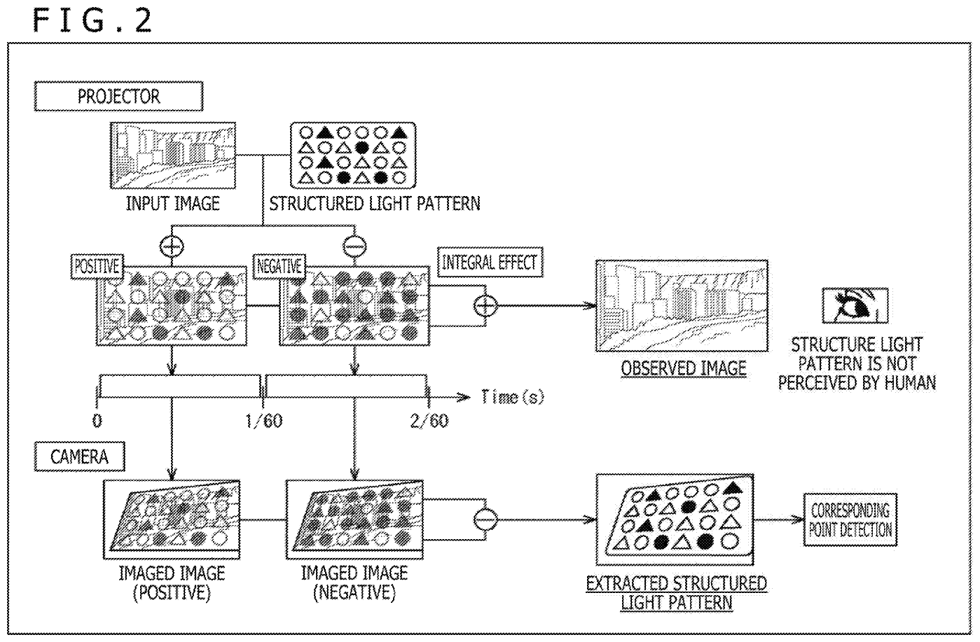

A method of detecting the corresponding point during projection of a moving image and estimating the postures of the projector and the camera will be referred to as on-line sensing. Methods of detecting the corresponding point using the on-line sensing include Imperceptible Structured Light (ISL) (FIG. 2) according to which a pattern imperceptible by the eyes of a human is superimposed on a moving image and the corresponding point is thereby detected, and a method according to which characteristic points in a moving image are detected and correlation of the characteristic points with each other is executed.

An ISL scheme is a technique of positive-negative-inverting a structured-light pattern that is an image of a predetermined pattern, burying the inverted image in a projection image, and projecting the inverted image to be imperceptible by a human.

As depicted in FIG. 2, the projector adds the predetermined structured-light pattern to a certain frame having an input image present therein, thereby produces a frame image having therein a positive image of the structured-light pattern coupled with the input image, subtracting the structured-light pattern from the frame next to the input image, and thereby produces a frame image having therein the negative image of the structured-light pattern coupled with the input image. The projector thereafter consecutively projects those frames. The two frames of the positive frame and the negative frame switched therebetween at a high speed are sensed by the eyes of a human being added to each other due to an integral effect. As a result, it is difficult for a user watching the projection image to recognize the structured-light pattern buried in the input image.

In contrast, the camera images the projection images of these frames, determines the difference between the imaged images of both frames, and thereby extracts only the structured-light pattern included in the imaged images. Detection of the corresponding point is executed using the extracted structured-light pattern.

In this manner, in the ISL scheme, the structured-light pattern can easily be extracted by only determining the difference between the imaged images and the detection of the corresponding point can therefore be executed with stable precision without depending on the projected image.

<Test Pattern of this Technique>

The test pattern of this technique is a pattern that is used in the above SL scheme, the above ISL scheme, and the like. A pattern having a plurality of one-dots (one-pixels) arranged therein at known intervals is handled as a small pattern in one area and the plurality of small patterns are arranged in the projection plane as the basic configuration of the test pattern of this technique.

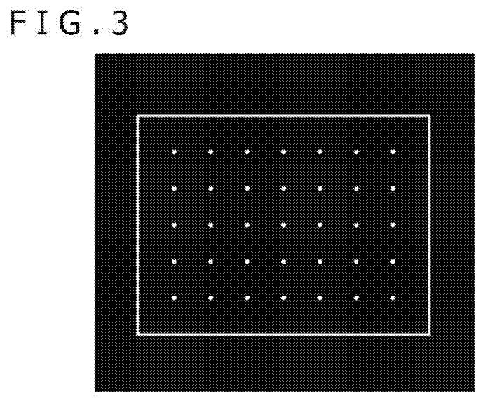

FIG. 3 is a diagram depicting an example of the configuration of the small pattern in the test pattern to which this technique is applied. In the example in FIG. 3, the small pattern is depicted as a pattern having all of a total of 35 dots that are lateral seven dots×longitudinal five dots arranged therein at intervals of each 14 pixels and a line having a width of one pixel (the outer frame) surrounds the 35 dots. In addition, the width of the outer frame may not be one pixel but may be several pixels while the width of one pixel is advantageous.

In addition, the number of the one-dots and the number of pixels of the interval between the dots (the between-dot distance) are not limited to the above, and a combination is applicable of various numbers for the number of the dots that is equal to or greater than two and for the between-dot distance that is sufficiently greater than the degree of blurring of the projector. Moreover, all the between-dot distances do not need to be equal in the small pattern, and the dots may be arranged to have various dimensions. The precision of the dot size calculation described later can also be improved.

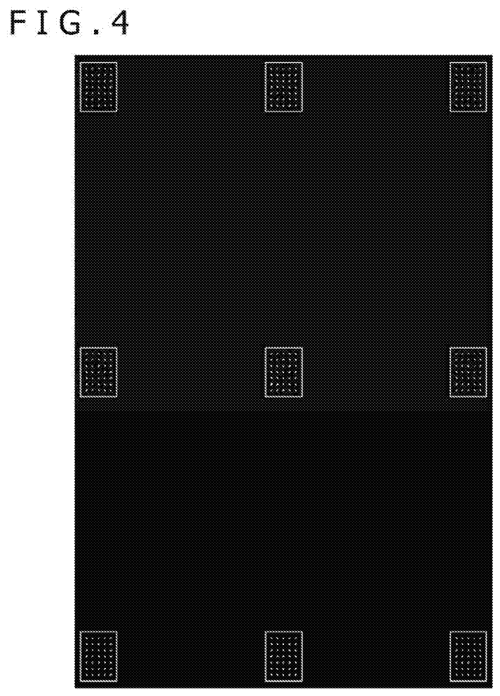

FIG. 4 is a diagram depicting an example of an overall test pattern that has a plurality of small patterns depicted in FIG. 3 arranged therein and that is projected into the overall image (hereinafter, simply referred to as a test pattern). In the example in FIG. 4, an example having a total of nine small patterns of laterally three×vertically three small patterns arranged therein while the number of the small patterns to be arranged therein is not limited to this.

In this technique, the test pattern as depicted in FIG. 4 is projected from the projector and the PSF (Point Spread Function) of the projector is determined from the image obtained by imaging the state of the projection using a camera.

In addition, in this case, the PSF is calculated at the place having the small pattern arranged therein while, in each of the places from which the PSF is not calculated, the PSF thereof can be calculated from the PSFs of the places around this place calculated from those of the places for the arrangement using linear interpolation or the like.

### <Example of Configuration of Projection Imaging System>

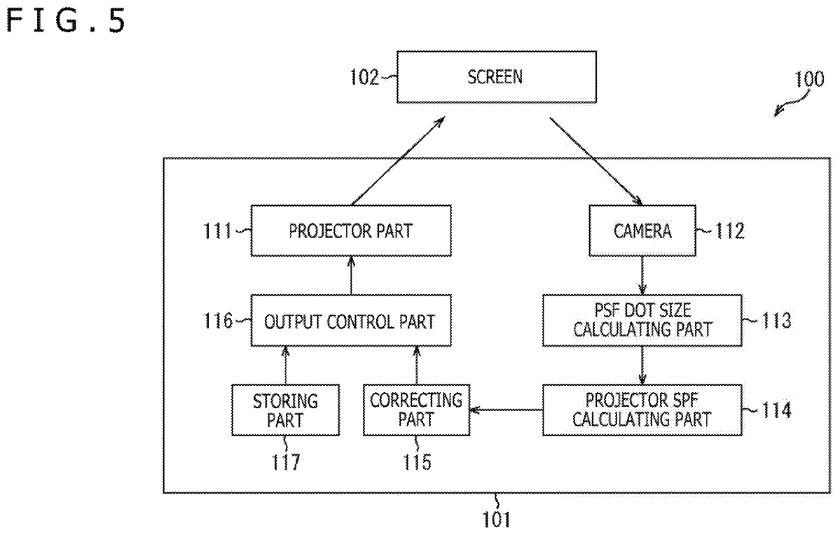

FIG. 5 is a block diagram depicting an example of the configuration of a projection imaging system to which this technique is applied. In the example in FIG. 5, the projection imaging system 100 is configured by a projection imaging apparatus 101 and a screen 102.

In the example in FIG. 5, the projection imaging apparatus 101 includes a projector 111, a camera 112, a PSF dot size calculating part 113, a projector PSF calculating part 114, a correcting part 115, an output control part 116, and a storing part 117.

The projector 111 projects the test pattern from the storing part 117 and a corrected image from the correcting part 115 onto the screen 102 when necessary. The camera 112 images the projection image projected from the projector 111 onto the screen, produces an imaged image, and supplies the imaged image to the PSF dot size calculating part 113.

In addition, a plurality of projectors 111 and a plurality of cameras 112 may both be present. Moreover, the one camera 112 may be present for the projector 111, the one camera 112 may be present for the plurality of projectors 111, or the one projector 111 may be present for the plurality of cameras 112.

The PSF dot size calculating part 113 calculates the PSF in the imaged image (referred to as a camera scale PSF) and the number of pixels corresponding to the one pixel of the projector in the imaged image (referred to as dot size), from the imaged image from the camera 112. The PSF dot size calculating part 113 supplies the calculated camera scale PSF and the calculated dot size to the projector PSF calculating part 114.

The projector PSF calculating part 114 calculates a projector scale PSF on the bases of the camera scale PSF and the dot size from the PSF dot size calculating part 113, and supplies the calculated projector scale PSF to the correcting part 115.

The correcting part 115 refers to the projector scale PSF from the projector PSF calculating part 114, corrects the imaged image such that the imaged image from the camera 112 can correctly be seen, thereby produces a corrected image, and outputs the produced corrected image to the output control part 116.

The storing part 117 stores therein the test pattern and the like. The output control part 116 executes control for outputting the test pattern of the storing part 117 or the corrected image from the correcting part 115, to the projector 111.

### <Example of Configuration of PSF Dot Size Calculating Part>

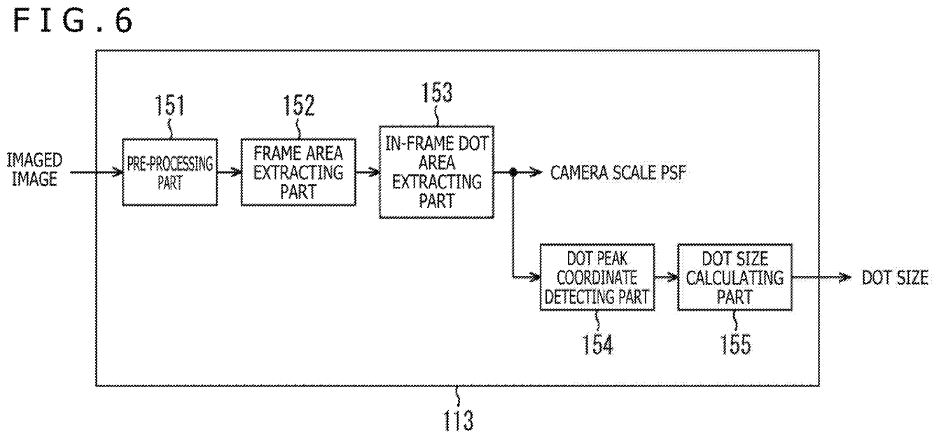

FIG. 6 is a block diagram depicting an example of the configuration of the PSF dot size calculating part.

In the example in FIG. 6, the PSF dot size calculating part 113 includes a pre-processing part 151, a frame area extracting part 152, an in-frame dot area extracting part 153, a dot peak coordinate detecting part 154, and a dot size calculating part 155.

The pre-processing part 151 executes a pre-process of extracting only the component for one channel such as a brightness image, a grayscale image, or the like from input data obtained by color-imaging (the imaged image). In the case where the imaged image is RAW data, a development process is also included in the pre-processing.

The frame area extracting part 152 removes an imaging noise included in the data for the one channel extracted by the pre-processing part 151 using binarization, a labeling process, or the like, and thereby extracts the frame area.

For the extracted data indicating only the content in the frame, the in-frame dot area extracting part 153 further executes separation of the imaging noise and the dots from each other using binarization, a labeling process, or the like, and determines the one having a large area as an object, to be a dot area. Concerning this, the extracted dot area is the camera scale PSF. The in-frame dot area extracting part 153 supplies the camera scale PSF to the projector PSF calculating part 114.

The dot peak coordinate detecting part 154 detects the maximal brightness point and the center-of-gravity point in the dot area from the in-frame dot area extracting part 153, as dot coordinates. The dot size calculating part 155 can determine the distance between each two dots in the imaged image using the dot coordinates detected by the dot peak coordinate detecting part 154, and calculates the dot size by dividing the distance by the interval of one dot in the pattern that corresponds to the between-dot distance. The dot size calculating part 155 supplies the calculated dot size to the projector PSF calculating part 114.

The projector PSF calculating part 114 can determine the projector scale PSF by executing a scaling process for the camera scale PSF from the in-frame dot area extracting part 153 using the dot size from the dot size calculating part 155.

### <Example of Operation of Projection Imaging System>

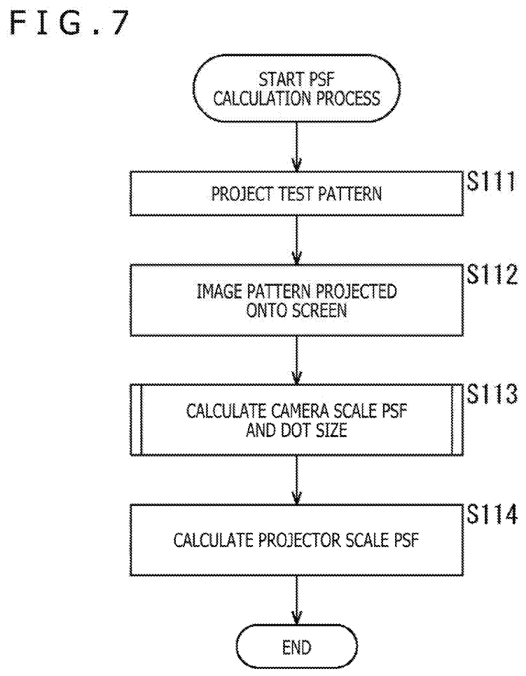

A PSF calculation process will be described next with reference to a flowchart in FIG. 7.

At step S111, the projector 111 projects the test pattern read by the output control part 116 from the storing part 117, toward the screen. At step S112, the camera 112 images the pattern projected onto the screen, produces the imaged image, and supplies the imaged image to the PSF dot size calculating part 113.

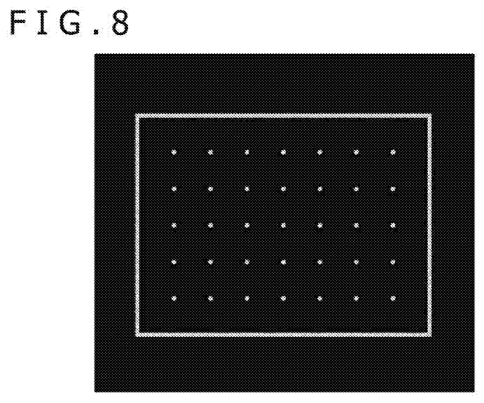

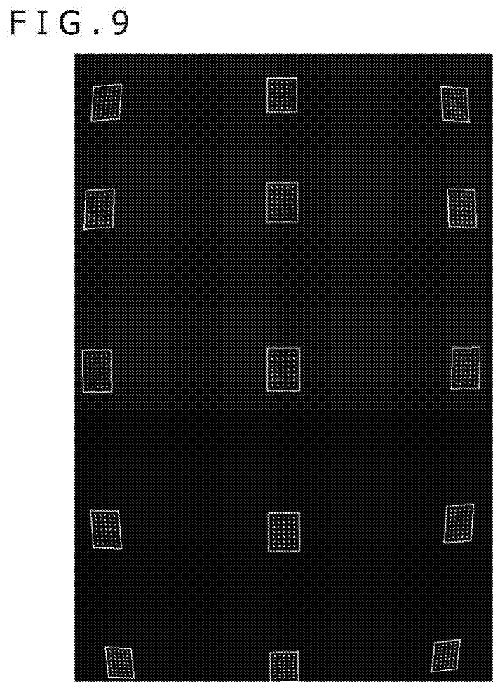

For example, FIG. 8 is a diagram depicting an example of the imaged image obtained by imaging only one projected small pattern. FIG. 9 is a diagram depicting an example of the imaged image obtained by imaging a plurality of projected small patterns at one time.

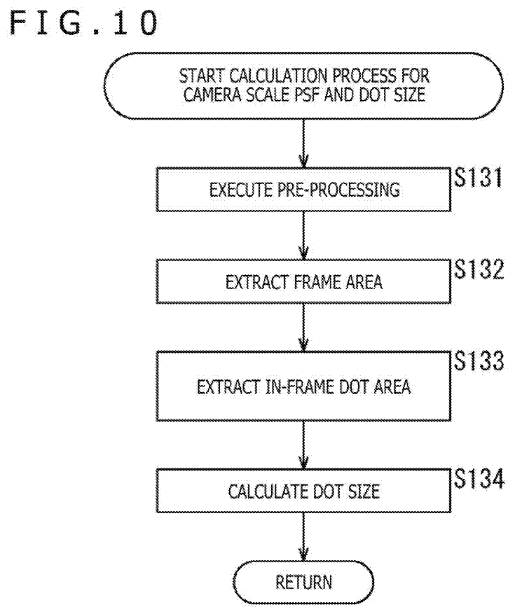

At step S113, the PSF dot size calculating part 113 calculates the camera scale PSF and the dot size from the imaged image from the camera 112. This calculation process of the camera scale PSF and the dot size will be described with reference to FIG. 10. The camera scale PSF and the dot size are calculated in the process at step S113 and are supplied to the projector PSF calculating part 114.

At step S114, the projector PSF calculating part 114 calculates the projector scale PSF on the basis of the camera scale PSF and the dot size from the PSF dot size calculating part 113.

The calculation process of the camera scale PSF and the dot size at step S113 in FIG. 7 will be described with reference to a flowchart in FIG. 10.

At step S131, the pre-processing part 151 executes the pre-processing of extracting only the component for the one channel such as the brightness image or the grayscale image, from the color-imaged input data (the imaged image).

At step S132, the frame area extracting part 152 removes the imaging noise included in the data for the one channel extracted at step S131 using binarization, a labeling process, or the like, and thereby extracts the frame area. For example, as described above with reference to FIG. 9, in the case where an image obtained by imaging the plurality of small patterns as one image constitutes the input, a plurality of frames is extracted. In this case, rough coordinates of the pattern desired to be extracted are provided and the frame closest to the coordinates is extracted.

At step S133, the in-frame dot area extracting part 153 extracts an in-frame dot area. In other words, the in-frame dot area extracting part 153 further executes separation of the imaging noise and the dots from each other using binarization, a labeling process, or the like for the extracted data indicating only the content in the frame, and determines the one having a large area as an object, to be a dot area. Concerning this, the extracted dot area is the camera scale PSF. The in-frame dot area extracting part 153 supplies the camera scale PSF to the projector PSF calculating part 114.

At step S134, the dot peak coordinate detecting part 154 and the dot size calculating part 155 calculates the dot size. In other words, the dot peak coordinate detecting part 154 detects the maximal brightness point and the center-of-gravity point in the dot area from the in-frame dot area extracting part 153, as dot coordinates. The dot size calculating part 155 can determine the distance between each two dots in the imaged image using the dot coordinates detected by the dot peak coordinate detecting part 154, and calculates the dot size by dividing the distance by the interval of one dot in the pattern that corresponds to each between-dot distance. The dot size calculating part 155 supplies the calculated dot size to the projector PSF calculating part 114.

Because the camera scale PSF and the dot size are calculated as above, at step S114 in FIG. 7, the projector PSF calculating part 114 can determine the projector scale PSF by executing the scaling process for the camera scale PSF from the in-frame dot area extracting part 153 using the dot size from the dot size calculating part 155.

In this technique, furthermore, using this small pattern as one area, a number, a code, or the like different for each pattern is added to the vicinity of the outer frame of the pattern. The places each having the small pattern arranged therein can be identified.

### <Example of Information to be Added to Small Pattern>

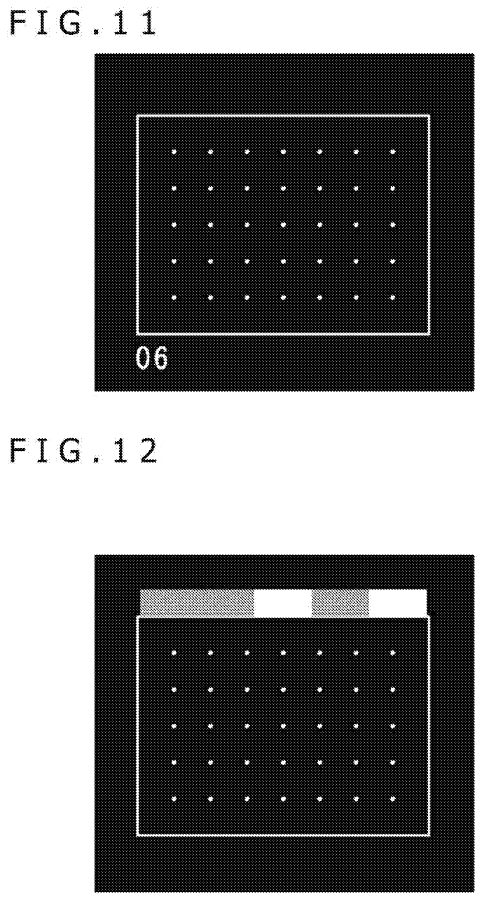

FIG. 11 to FIG. 17 are each diagrams depicting an example of the information to be added to the small pattern.

FIG. 11 is a diagram depicting an example of a pattern for which the position information is displayed as a number. For example, in the example in FIG. 11, the number (06) that is the position information is arranged at the lower left in the outer frame of the small pattern.

FIG. 12 is a diagram depicting an example of the pattern for which the position information is displayed as a binary code. For example, in the example in FIG. 12, the binary code indicating the number of the position information is arranged above the outer frame of the small pattern.

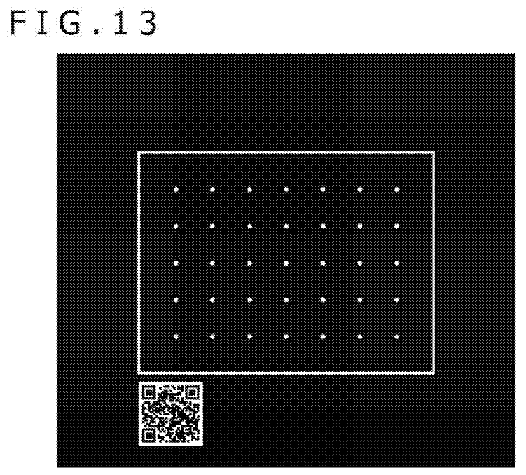

FIG. 13 is a diagram depicting an example of the pattern for which the position information is displayed using a QR code. For example, in the example in FIG. 13, the QR code that indicates the number of the position information is arranged at the lower left in the outer frame of the small pattern.

In addition, in each of the examples in FIG. 11 to FIG. 13, the position for the position information to be arranged is not limited to each of the described examples and may be anywhere only when the position is in the vicinity of the outer frame.

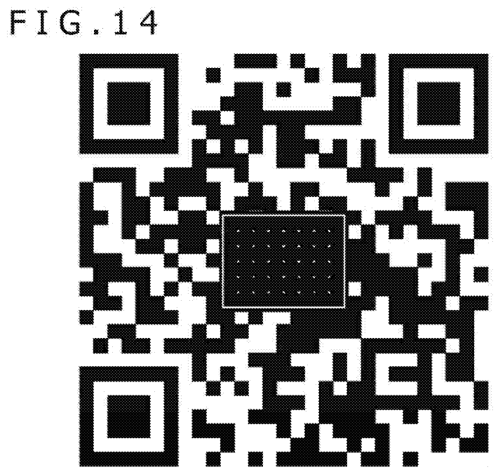

FIG. 14 is a diagram depicting another example of the pattern for which the position information is displayed using a QR code. For example, in the example in FIG. 14, the small pattern is arranged in the QR code indicating the number of the position information.

The example where the small pattern is arranged at the center of the QR code has been described in the example in FIG. 14 while the small pattern may be arranged anywhere only when the small pattern is in the QR code. Not limiting to this example, it is however advantageous that the white area is reduced as small as possible.

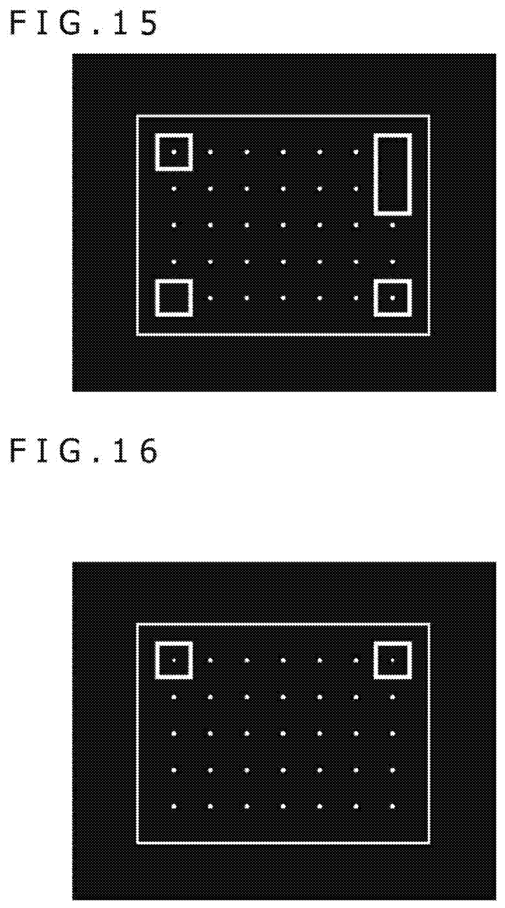

FIG. 15 is a diagram depicting an example of the pattern indicating the position information using the number and the arrangement of one-dots included in the outer frame. For example, the position information is indicated by a displaying state and a non-displaying state of each of dots at five positions each surrounded by a solid line (at the upper left corner, the lower left corner, upper right corner, immediately beneath the upper right corner, and the lower right corner). In the example in FIG. 15, of the five positions each surrounded by the solid line, the dots at the upper left corner and the lower right corner are in the displaying state, and the dots at the lower left corner, the upper right corner, and the immediately beneath the upper right corner are in the non-displaying state. In addition, the solid lines in FIG. 15 are not displayed in practice.

FIG. 16 is a diagram depicting an example of the pattern indicating the position information using the brightness of one dot included in the outer frame. For example, the position information is indicated by varying the brightness of the dots at two positions (the upper left corner and the upper right corner) each surrounded by a solid line. In the example in FIG. 16, the brightness at the two positions each surrounded by the solid line is set to be low. In addition, the solid lines in FIG. 16 are also not displayed in practice. In the case of the examples in FIG. 15 and FIG. 16, the positions of the targets to be surrounded by the solid line may be any positions only when the positions are determined.

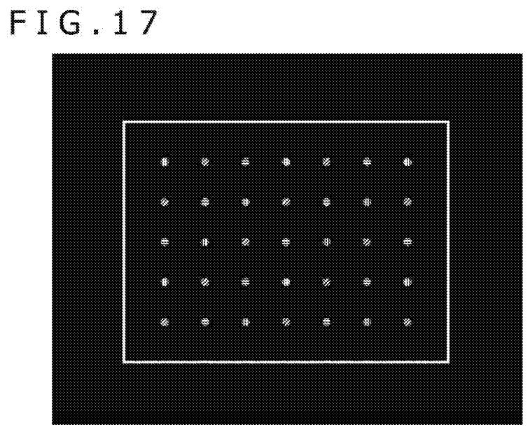

FIG. 17 is a diagram depicting an example of the pattern indicating the position information using the values of the RGB channels of one dot included in the outer frame. For example, the position information is indicated by setting the values of the RGB channel of each of the dots included in the outer frame, to be different from each other. In the example of FIG. 17, each of the dots is constituted by any one of the R, the G, and the B.

In addition, in FIG. 16 and FIG. 17, the position information can be expressed by varying the order of lining the one-dots each having the brightness or the values of the RGB channel different from each other, in accordance with the position thereof. Moreover, as in the example in FIG. 17, the RSF of each of the R, the G, and the B can be obtained by arranging the dots separately for each of the R, the G, and the B.

As above, according to this technique, the test pattern is projected, and the shape of the PSF separately for each of the R, the G, and the B in the scale of the projector and the position in the projection plane corresponding to each of the PSFs can be determined from the image obtained by imaging.

The absolute dimension of the PSF can thereby be determined in both of the cases where the overall projection plane is imaged in one image and where the patterns at the positions are each separately imaged, and an effect is achieved that the constraints are alleviated when the imaging is executed. Another effect is also achieved that the obtained PSF at each of the positions can be used for evaluation of the lens of the projector and blurring correction of the lens.

### <Personal Computer>

The series of processes described above can be executed by hardware or can also be executed by software. In the case where the series of processes are executed by the software, the programs constituting the software are installed in a computer. Concerning this, types of this computer include a computer incorporated in dedicated hardware, a general-purpose personal computer capable of executing various functions by installing therein various programs, and the like.

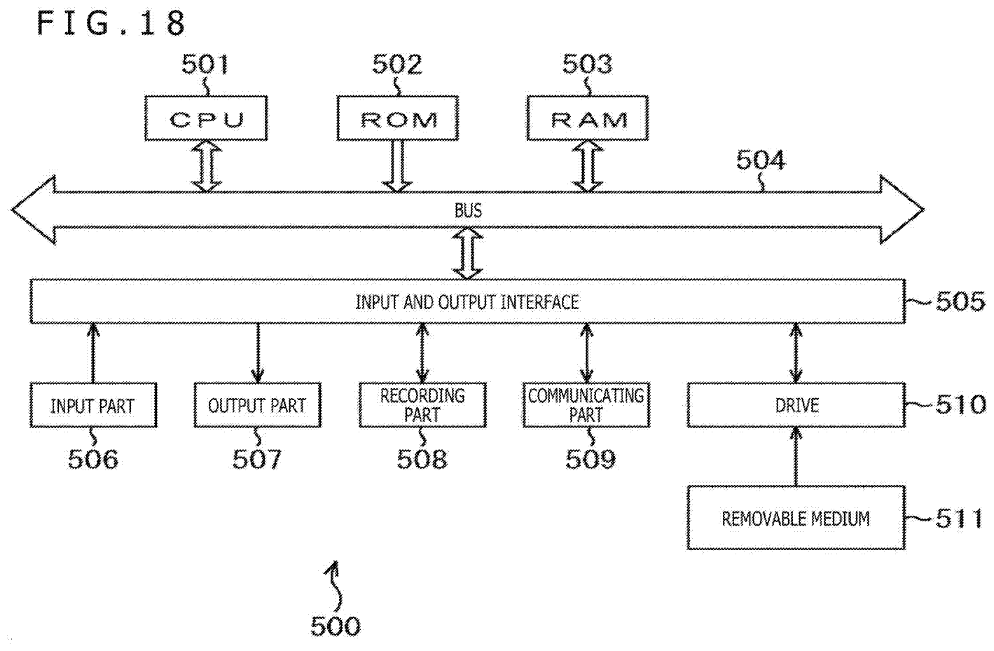

FIG. 18 is a block diagram depicting an example of the hardware configuration of a personal computer that executes the above series of processes in accordance with programs.

In the personal computer 500, a CPU (Central Processing Unit) 501, a ROM (Read Only Memory) 502, and a RAM (Random Access Memory) 503 are connected to each other by a bus 504.

An input and output interface 505 is further connected to the bus 504. To the input and output interface 505, an input part 506, an output part 507, a storing part 508, a communicating part 509, and a drive 510 are connected.

The input part 506 includes a keyboard, a mouse, a microphone, and the like. The output part 507 includes a display, a speaker, and the like. The storing part 508 includes a hard disk, a non-volatile memory, and the like. The communicating part 509 includes a network interface and the like. The drive 510 drives a removable medium 511 such as a magnetic disk, an optical disk, a magnetooptical disk, a semiconductor memory, and the like.

In the personal computer 500 configured as above, the CPU 501 loads, for example, programs stored in the storing part 508 on the RAM 503 through the input and output interface 505 and the bus 504 and execute the programs. The above series of processes are thereby executed.

The programs executed by the computer (the CPU 501) can be provided being recorded in the removable medium 511. The removable medium 511 is, for example, a magnetic disk (including a flexible disk), an optical disk (such as a CD-ROM (Compact Disc-Read Only Memory), a DVD (Digital Versatile Disc), or the like), a magnetooptical disk, or a package medium including a semiconductor memory or the like. Moreover, otherwise, the programs can be provided through a wired or a wireless transmission medium such as a local area network, the Internet, or digital satellite broadcasting.

In the computer, the programs can be installed in the storing part 508 through the input and output interface 505 by attaching the removable medium 511 into the drive 510. Moreover, the programs can be installed in the storing part 508 by being received by the communicating part 509 through a wired or a wireless transmission medium. In addition, the programs can be installed in advance in the ROM 502 or the storing part 508.

In addition, the programs executed by the computer may be programs for the processes based thereon to be executed in chronological order in accordance with the order described herein or may be programs for which the processes based thereon are executed in parallel to each other or each in a necessary stage such as the time when the process is invoked.

Moreover, in this specification, the step of describing the programs to be recorded in the recording medium surely includes the processes executed in chronological order in accordance with the described order and also the processes that are not necessarily executed in chronological order but that are executed in parallel to each other or each executed separately from each other.

Moreover, in this specification, the system represents the overall apparatus constituted by a plurality of devices (apparatuses).

For example, this disclosure can take a configuration of cloud computing according to which a plurality of apparatuses processes one function through a network, sharing the processing thereby and in cooperation with each other.

Moreover, in the above, the configuration described as one apparatus (or one processing part) may be divided to be configured as a plurality of apparatuses (or a plurality of processing parts). In contrast, the configuration described as a plurality of apparatuses (or a plurality of processing parts) in the above may be integrated to be configured as one apparatus (or one processing part). Moreover, configurations other than those described above may surely be added to the configuration of each of the apparatuses (or each of the processing parts). Furthermore, only when the configuration and the operation as the overall system are substantially same, a portion of the configuration of a certain apparatus (or a certain processing part) may be included in the configuration of another apparatus (or another processing part). In short, this technique is not limited to the above embodiment and various changes can be made thereto within the scope not departing from the gist of this technique.

The preferred embodiment of this disclosure has been described in detail with reference to the accompanying drawings in the above while this disclosure is not limited to the example. It is obvious for those skilled in the art to which this disclosure pertains to be able to conceive various variation examples or various modification examples within the scope of the technical idea described in the appended claims, and it is understood that these examples are naturally included in the technical scope of this disclosure.

In addition, this technique may also take the following configurations.

(1) An image processing apparatus including:

a PSF calculating part that projects a test pattern having a plurality of small patterns arranged in an overall projection plane, the plurality of small patterns each having a plurality of one-pixels arranged at predetermined intervals each in a predetermined area and that calculates a PSF (Point Spread Function) of a projector at each of positions in the projection plane, using an imaged image obtained by imaging the projected test pattern.

(2) The image processing apparatus described in the above (1), in which

the test pattern is configured having the plurality of small patterns arranged therein that are each added with position information indicating the position of the small pattern in the projection plane.

(3) The image processing apparatus described in the above (2), in which

the small pattern is added with a number as the position information.

(4) The image processing apparatus described in the above (2), in which

the small pattern is added with a binary code as the position information.

(5) The image processing apparatus described in the above (2), in which

the small pattern is added with a QR code as the position information.

(6) The image processing apparatus described in the above (1), in which

the test pattern is configured having the plurality of small patterns arranged therein that each include position information using at least one of a number, arrangement, brightness, or a color of one pixel in the small pattern.

(7) The image processing apparatus described in any one of the above (1) to (6), in which

the PSF calculating part includes:

a PSF dot size calculating part that calculates a PSF of a camera scale and a dot size using the imaged image; and

a projector PSF calculating part that calculates a PSF of the projector by scaling the PSF of the camera scale calculated by the PSF dot size calculating part, using the dot size calculated by the PSF dot size calculating part.

(8) The image processing apparatus described in any one of the above (1) to (7), in which

the test pattern is used for Structured Light (SL).

(9) The image processing apparatus described in any one of the above (1) to (7), in which

the test pattern is used for Imperceptible Structured Light (ISL).

(10) An image processing method including:

by an image processing apparatus
projecting a test pattern having a plurality of small patterns arranged in an overall projection plane, the plurality of small patterns each having a plurality of one-pixels arranged at predetermined intervals each in a predetermined area; and
calculating a PSF (Point Spread Function) of a projector at each of positions in the projection plane, using an imaged image obtained by imaging the projected test pattern.

(11) A program causing a computer to function as:

a PSF calculating part that projects a test pattern having a plurality of small patterns arranged in an overall projection plane, the plurality of small patterns each having a plurality of one-pixels arranged at predetermined intervals each in a predetermined area, and that calculates a PSF (Point Spread Function) of a projector at each of positions in the projection plane, using an imaged image obtained by imaging the projected test pattern.

### REFERENCE SIGNS LIST

100 Projection imaging system, 101 Projection imaging apparatus, 102 Screen, 111 Projector, 112 Camera, 113 PSF dot size calculating part, 114 Projector PSF calculating part, 115 Correcting part, 116 Output control part, 117 Storing part, 151 Pre-processing part, 152 Frame area extracting part, 153 In-frame dot area extracting part, 154 Dot peak coordinate detecting part, 155 Dot size calculating part

1. An image processing apparatus comprising:
a PSF calculating part that projects a test pattern having a plurality of small patterns arranged in an overall projection plane, the plurality of small patterns each having a plurality of one-pixels arranged at predetermined intervals each in a predetermined area, and that calculates a PSF (Point Spread Function) of a projector at each of positions in the projection plane, using an imaged image obtained by imaging the projected test pattern.

2. The image processing apparatus according to claim 1, wherein
the test pattern is configured having the plurality of small patterns arranged therein that are each added with position information indicating the position of the small pattern in the projection plane.

3. The image processing apparatus according to claim 2, wherein
the small pattern is added with a number as the position information.

4. The image processing apparatus according to claim 2, wherein
the small pattern is added with a binary code as the position information.

5. The image processing apparatus according to claim 2, wherein
the small pattern is added with a QR code as the position information.

6. The image processing apparatus according to claim 1, wherein
the test pattern is configured having the plurality of small patterns arranged therein that each include position information using at least one of a number, arrangement, brightness, or a color of one pixel in the small pattern.

7. The image processing apparatus according to claim 1, wherein
the PSF calculating part includes:
a PSF dot size calculating part that calculates a PSF of a camera scale and a dot size using the imaged image; and
a projector PSF calculating part that calculates a PSF of the projector by scaling the PSF of the camera scale calculated by the PSF dot size calculating part, using the dot size calculated by the PSF dot size calculating part.

8. The image processing apparatus according to claim 1, wherein
the test pattern is used for Structured Light (SL).

9. The image processing apparatus according to claim 1, wherein
the test pattern is used for Imperceptible Structured Light (ISL).

10. An image processing method comprising:
by an image processing apparatus
projecting a test pattern having a plurality of small patterns arranged in an overall projection plane, the plurality of small patterns each having a plurality of one-pixels arranged at predetermined intervals each in a predetermined area; and
calculating a PSF (Point Spread Function) of a projector at each of positions in the projection plane, using an imaged image obtained by imaging the projected test pattern.

11. A program causing a computer to function as:
a PSF calculating part that projects a test pattern having a plurality of small patterns arranged in an overall projection plane, the plurality of small patterns each having a plurality of one-pixels arranged at predetermined intervals each in a predetermined area, and that calculates a PSF (Point Spread Function) of a projector at each of positions in the projection plane, using an imaged image obtained by imaging the projected test pattern.
